(19) United States
(12) Patent Application Publication
(10) Pub. No.: US 2016/0161649 A1
(43) Pub. Date: Jun. 9, 2016

(54) DISPLAY SUBSTRATE AND MANUFACTURING METHOD THEREOF, AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD, Anhui (CN)

(72) Inventors: Huifang YUAN, Beijing (CN); Sangman YUK, Beijing (CN)

(21) Appl. No.: 14/742,170

(22) Filed: Jun. 17, 2015

(30) Foreign Application Priority Data
Dec. 4, 2014 (CN) 201410735119.3

(51) Int. Cl. G02B 5/20; G02B 5/00

(52) U.S. Cl. CPC G02B 5/201; G02B 5/003

(57) ABSTRACT

The present invention provides a display substrate and a manufacturing method thereof, and a display device, the display substrate comprises an active area, a first black matrix and a light leaking region, the first black matrix surrounding the active area, and the light leaking region surrounding the periphery of the first black matrix, wherein the display substrate further comprises a filter layer surrounding the first black matrix, the filter layer covers the light leaking region so as to reduce the transmittance of light at the light leaking region, and the resistivity of the filter layer is larger than that of the first black matrix. In the display substrate, the light leaking region is covered by the filter layer, the transmittance of light at light leaking region is thus reduced, therefore, likelihood of viewer observing light leakage at the light leaking region may be decreased.

### FIELD OF THE INVENTION

The present invention relates to the field of liquid crystal display technology, and particularly to a display substrate and a manufacturing method thereof, and a display device.

### BACKGROUND OF THE INVENTION

An existing liquid crystal display device in ADS mode comprises an array substrate and a color filter substrate, which are aligned and assembled together to form a cell, and a liquid crystal layer filled between the array substrate and the color filter substrate. FIG. 1 is a diagram of a color filter substrate in a liquid crystal display device in ADS mode. As shown in FIG. 1, the color filter substrate comprises a base substrate 10, and a color filter sheet 11 and a black matrix 12 formed on the color filter substrate 10. The color filter sheet 11 comprises filters with various colors, so that each of a plurality of sub-pixels forming a pixel displays a corresponding color. The black matrix 12 comprises a first black matrix 120 and a second black matrix 121, the first black matrix 120 is provided along the edges of the color filter substrate to form a circle, a region inside which corresponds to an active area 13 of the display device; the second black matrix 121 comprises a plurality of black matrix strips successively provided in a row direction and a column direction of the display device respectively, and is used to shield gate lines, data lines and other signal lines of the display device; the first black matrix 120 and the second black matrix 121 are made of material with low resistivity, so that resistances of the first black matrix 120 and the second black matrix 121 are specifically in the order of 107Ω, so as to remove static electricity during display and avoid the occurrence of image sticking during display.

Generally, when manufacturing a color filter substrate, structures such as color filter sheets 11 and black matrixes 12 for a plurality of color filter substrates are first formed on a large area base substrate 10, and then the resultant large area base substrate 10 is cut to obtain a plurality of color filter substrates. Regarding the manufacture of the color filter substrate shown in FIG. 1, when cutting, since the black matrix 12 has low resistivity, if cutting is performed along edges of the first black matrix 120, during usage of a display device adopting the cut color filter substrate, static electricity inside and outside the display device may be conducted through the first black matrix, which will cause a black image displayed on the display device to be greenish. Therefore, when cutting the color filter substrate shown in FIG. 1, cutting has to be performed outside the first black matrix 120 (wherein a region surrounded by the first black matrix 120 is called as “inside”, and a region not being surrounded by the first black matrix 120 is called as “outside”), and a cutting line is away from the outer edge of the first black matrix 120 by a preset distance, and in general, the preset distance is 0.2 mm.

In the above color filter substrate, regions outside the first black matrix 120 (that is, regions between outer edges of the first black matrix 120 and cutting lines) allow light to pass therethrough, which results in light leakage at edges of the display device adopting the above color filter substrate, in particularly, in the case that frames of the display device are narrow, shielding effect of the frames against light leakage is decreased, light leakage may be more serious and remarkable, thus display effect of the display device will be largely affected.

### SUMMARY OF THE INVENTION

The present invention is directed to at least solve one of problems existing in the prior art, and proposes a display substrate and a manufacturing method thereof, a display panel and a display device, which can reduce the transmittance of light at a light leaking region, so as to decrease brightness of the light leaking region and decrease likelihood of viewer observing light leakage at the light leaking region.

In order to realize the object of the present invention, provided is a display substrate, comprising an active area, a first black matrix and a light leaking region, the first black matrix surrounding the active area, and the light leaking region surrounding the periphery of the first black matrix, wherein the display substrate further comprises a filter layer surrounding the first black matrix, the filter layer covers the light leaking region so as to reduce the transmittance of light at the light leaking region of the display substrate, and the resistivity of the filter layer is larger than that of the first black matrix.

Preferably, the display substrate is formed thereon with color filters with various colors, the filter layer has the same as color filters of one color, and pattern of the filter layer and patterns of the color filters with the same color as the filter layer are provided in the same layer.

Preferably, the color of the filter layer is any one of red, green and blue.

Preferably, the filter layer comprises a first filter layer and a second filter layer; the display substrate is formed thereon with color filters with various colors, the first filter layer has the same color as color filters with one color and the second filter layer has the same color as color filters with another color; a pattern of the first filter layer and patterns of the color filters with the same color as the first filter layer are provided in the same layer, and a pattern of the second filter layer and patterns of the color filters with the same color as the second filter layer are provided in the same layer.

Preferably, the transmittance of the filter layer is less than 30%.

Preferably, the filter layer is made of opaque material.

Preferably, inner part of the filter layer partially overlaps outer part of the first black matrix.

Preferably, a width of an overlapping area between the inner part of the filter layer and the outer part of the first black matrix is 6˜7 μm.

As another technical solution, the present invention further provides a manufacturing method of the above display substrate, wherein the manufacturing method comprises a step of forming a first black matrix and a step of forming a filter layer, so that the active area and the light leaking region of the display substrate are separated from each other by the first black matrix, the first filter layer covers the light leaking region outside the active area so as to reduce the transmittance of light at the light leaking region of the display substrate, and the resistivity of the filter layer is larger than that of the first black matrix.

Preferably, in the step of forming the filter layer, patterns of color filters with the same color as the filter layer are formed simultaneously.

Preferably, the step of forming the filter layer comprises: a step of forming a pattern of a first filter layer; and a step of forming a pattern of a second filter layer having a different color from the first filter layer; in the step of forming the pattern of the first filter layer, forming patterns of color filters with the same color as the first filter layer simultaneously; and in the step of forming the pattern of the second filter layer, forming patterns of color filters with the same color as the second filter layer simultaneously.

Preferably, the manufacturing method further comprises a step of cutting along outer edges of the light leaking region to obtain the display substrate, wherein the outer edge of the filter layer is located outside the outer edge of the light leaking region.

Preferably, a distance from the outer edge of the filter layer to the outer edge of the light leaking region adjacent to the outer edge of the filter layer is 0.2˜0.5 mm.

As still another technical solution, the present invention further provides a display panel comprising a display substrate and an assembling substrate, wherein the display substrate adopts the above display substrate provided by the present invention.

As still another technical solution, the present invention further provides a display device comprising a display panel, wherein the display panel adopts the above display panel provided by the present invention.

The present invention has following advantages:

In the display substrate provided by the present invention, the light leaking region is covered by a filter layer, the transmittance of light at light leaking region of the display substrate is thus reduced, so that brightness of the light leaking region is decreased, and even the light leaking region does not emit light, therefore, likelihood of viewer observing light leakage at the light leaking region may be decreased.

In the manufacturing method of a display substrate provided by the present invention, a step of forming a filter layer covering the light leaking region is included, thus the transmittance of light at light leaking region of the display substrate may be reduced, so that brightness of the light leaking region is decreased, and even the light leaking region does not emit light, therefore, likelihood of viewer observing light leakage at the light leaking region may be decreased.

In the display panel provided by the present invention, as the display panel adopts the display substrate provided by the present invention, thus the transmittance of light at light leaking region of the display substrate may be reduced, so that brightness of the light leaking region is decreased, and even the light leaking region does not emit light, therefore, likelihood of viewer observing light leakage at the light leaking region may be decreased, and light leakage defect of the light leaking region of the display panel is eliminated.

In the display device provided by the present invention, as the display device adopts the display panel provided by the present invention, thus likelihood of viewer observing light leakage at the light leaking region may be decreased, and light leakage defect of the light leaking region of the display panel is eliminated.

### BRIEF DESCRIPTION OF THE DRAWINGS

Accompanying drawings are used to provide further understanding of the present invention, constitute a part of the specification, and are used to explain the present invention together with following embodiments, but not to limit the present invention, wherein:

FIG. 1 is a diagram of a color filter substrate in a display device in ADS mode;

FIG. 2 is a diagram of a display substrate provided in a first embodiment of the present invention;

FIG. 3 is a cross-sectional diagram of left part of the display substrate in FIG. 2 taken along line A-A′;

FIG. 4 is a diagram of a display substrate provided in a second embodiment of the present invention.

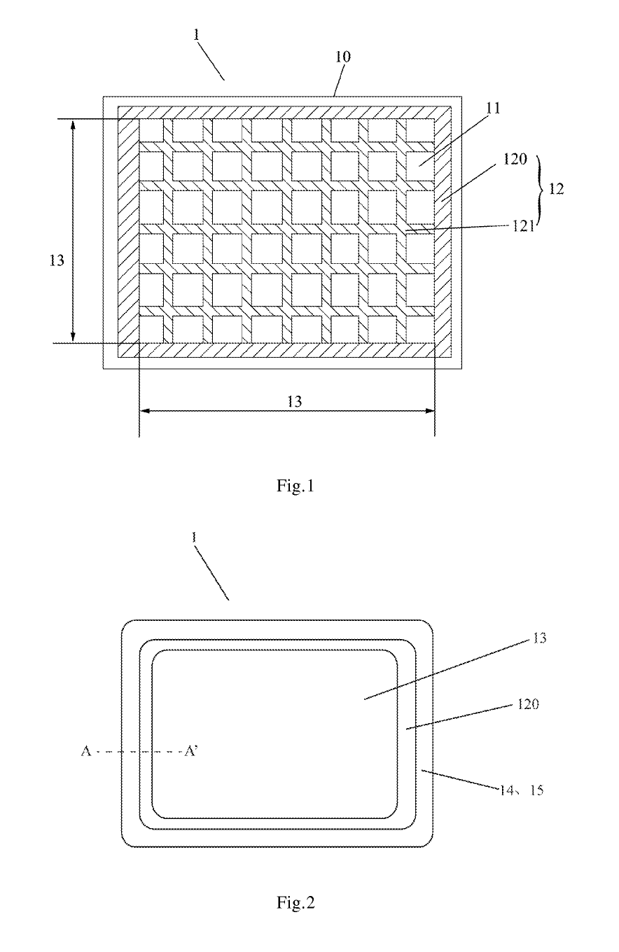

### DESCRIPTION OF REFERENCE NUMERALS

1: display substrate; 10: base substrate; 11: color filter sheet; 12: black matrix; 13: active area; 14: filter layer; 15: light leaking region; 120: first black matrix; 121: second black matrix; 140: first filter layer; 141: second filter layer.

### DETAILED DESCRIPTION OF THE EMBODIMENTS

Embodiments will be described in detail below in conjunction with the accompanying drawings. It should be understood that, the embodiments described herein are only used to describe and explain the present invention, but not to limit the present invention.

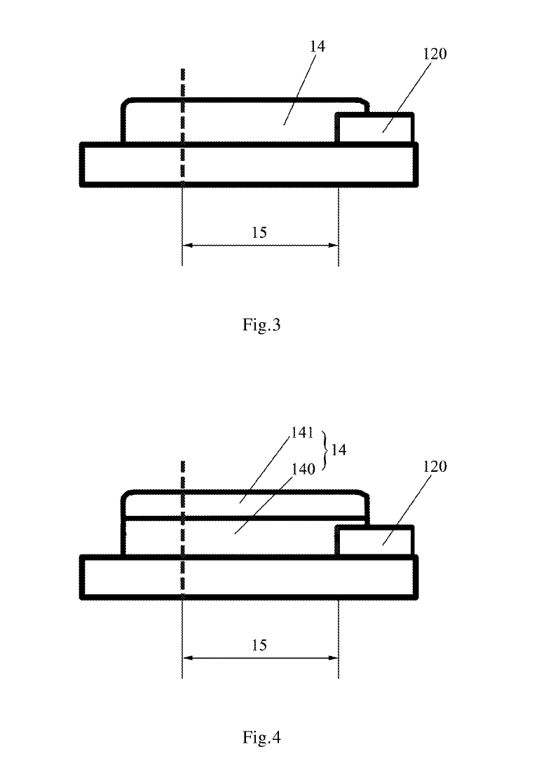

With reference to FIG. 2 and FIG. 3, FIG. 2 is a diagram of a display substrate provided in a first embodiment of the present invention; and FIG. 3 is a cross-sectional diagram of left part of the display substrate in FIG. 2 taken along line A-A′. In this embodiment, the display substrate 1 comprises an active area 13, a first black matrix 120 and a filter layer 14, the first black matrix 120 surrounds the active area 13, and a light leaking region 15 is located at the periphery of the first black matrix 120 and surrounds the first black matrix 120; the filter layer 14 surrounds the first black matrix 120 and covers the light leaking region 15 so as to reduce the transmittance of light at the light leaking region 15 of the display substrate 1, and the resistivity of the filter layer 14 is larger than that of the first black matrix 120. Specifically, the display substrate 1 may be an array substrate or a color filter substrate.

In the display substrate in the embodiment of the present invention, the filter layer 14 is provided and covers the light leaking region 15 outside the first black matrix 120. By providing the filter layer 14, when light passes through the light leaking region 15, transmittance of light at the light leaking region 15 can be reduced, that is to say, brightness of the light leaking region 15 can be reduced, thus likelihood of viewer observing light leakage at the light leaking region 15 is decreased. Thus, compared to the display panel of the existing display device, the display panel (mainly consisting of the display substrate 1, an assembling substrate, and a liquid crystal layer filled therebetween) including the display substrate 1 provided by the embodiment is used to display images, likelihood of viewers observing light leakage defect at the light leaking region 15 is reduced, and therefore display effect of the display panel is improved.

In this embodiment, the display substrate 1 is provided with color filters with various colors thereon, the color of the filter layer 14 may be the same as that of a color filter, and pattern of the filter layer 14 and patterns of the color filters with the same color are provided in the same layer. The so called “provided in the same layer” refers to be simultaneously formed in a single patterning process, but does not refer to have to be at the same height. The filter layer 14 is provided in the same layer as the color filters with the same color, that is, the filter layer 14 is formed while the color filters with the same color as the filter layer 14 is formed, thus addition of processes and time for manufacturing the display substrate 1 can be avoided, thus large increase in cost of the display substrate 1 can be suppressed, and large decrease in production efficiency of the display substrate 1 can be avoided. Moreover, in general, the resistivity of material for forming the color filters is larger than that of the first black matrix 120, and therefore, the first black matrix 120 and the color filters can be manufactured simultaneously in a single process.

Generally, colors of the color filters on the display substrate 1 include red, blue and green, and therefore, in this embodiment, the color of the filter layer 14 is any one of red, green and blue.

Besides the embodiment in which the color of the filter layer 14 is the same as that of a color filter on the display substrate 1, the color of the filter layer 14 may also be other color. The transmittance of the filter layer 14 is preferably less than 30%, thus likelihood of viewer observing light leakage at the light leaking region may be decreased to be within a preset allowance range. Further preferably, the filter layer 14 is made of opaque material, thus light can be completely prevented from passing through the light leaking region 15, so that viewer cannot observe light leakage at the light leaking region 15 completely, which solves the light leakage at the light leaking region 15 completely.

Preferably, inner part of the filter layer 14 partially overlaps outer part of the first black matrix 120. Thus a gap between the filter layer 14 and the first black matrix 120 due to patterning process error can be prevented from occurring during the manufacturing procedure.

Further preferably, a width of an overlapping area between the inner part of the filter layer 14 and the outer part of the first black matrix 120 is 6˜7 nm.

With reference to FIG. 4, FIG. 4 is a diagram of a display substrate provided in a second embodiment of the present invention. Compared to the first embodiment, the display substrate 1 of this embodiment also comprises a first black matrix 120 and a filter layer 14, wherein arrangements and functions of the first black matrix 120 and the filter layer 14 are the same as those in the above first embodiment, and since they have been described in detail in the first embodiment, description thereof is omitted herein.

Hereinafter, only differences between the display substrate of this embodiment and that of the above first embodiment will be described in detail.

In this embodiment, the filter layer 14 comprises a first filter layer 140 and a second filter layer 141; the display substrate 1 is formed thereon with color filters with various colors, the first filter layer 140 has the same color as color filters with one color and the second filter layer 141 has the same color as color filters with another color; a pattern of the first filter layer 140 and patterns of the color filters with the same color as the first filter layer are provided in the same layer, and a pattern of the second filter layer 141 and patterns of the color filters with the same color as the second filter layer are provided in the same layer.

In this embodiment, the filter layer 14 comprises a first filter layer 140 and a second filter layer 141, the first filter layer 140 has the same color as color filters with one color and the second filter layer 141 has the same color as color filters with another color, that is to say, the first filter layer 140 and the second filter layer 141 have different colors. When light irradiates to the light leaking region, it successively passes through the first filter layer 140 and the second filter layer 141 (in this embodiment, light first passes through the first filter layer 140). It should be understood that, when light passes through the first filter layer 140, light with different colors from the first filter layer 140 is filtered out, thus only light with the same color as the first filter layer 140 irradiates to the second filter layer 141, and moreover, since the transmitted light has different color from the second filter layer 141, the light passing through the first filter layer 140 is filtered out by the second filter layer 141, so that light irradiating to the light leaking region 15 is completely filtered out, the viewer cannot observe light leakage, therefore, light leakage cannot occur in the display panel adopting the display substrate 1 in this embodiment.

Meanwhile, a pattern of the first filter layer 140 and patterns of the color filters with the same color as the first filter layer are provided in the same layer, a pattern of the second filter layer 141 and patterns of the color filters with the same color as the second filter layer are provided in the same layer. Thus, the first filter layer 140 and the second filter layer 141 may be formed while color filters with the same colors as the first filter layer 140 and the second filter layer 141 are formed respectively, thus addition of processes and time for manufacturing the display substrate 1 can be avoided, thus large increase in cost of manufacturing the display substrate 1 can be suppressed, and large decrease in production efficiency of the display substrate 1 can be avoided. Generally, colors of the color filters on the display substrate 1 include red, green and blue, and therefore, in this embodiment, the colors of the first filter layer 140 and the second filter layer 141 may be any two of red, green and blue, for example, the first filter layer 140 is red, and the second filter layer 141 is blue.

In summary, in the display substrates 1 in the first embodiment and the second embodiment, the light leaking region 15 is covered with the filter layer 14, thus the transmittance of light at the light leaking region 15 is reduced, so that the brightness of the light leaking region 15 is decreased, and even the light leaking region 15 cannot emit light, therefore, likelihood of viewer observing light leakage at the light leaking region may be decreased.

As another technical solution, an embodiment of the present invention further provides a manufacturing method of a display substrate for manufacturing the above display substrates in the above first embodiment and second embodiment. In this embodiment, the manufacturing method comprises a step of forming a first black matrix and a step of forming a filter layer, so that the active area and the light leaking region of the display substrate is separated from each other by the first black matrix, the filter layer covers the light leaking region outside the active area so as to reduce the transmittance of light at the light leaking region of the display substrate, and the resistivity of the filter layer is larger than that of the first black matrix.

Specifically, the so called “display substrate” may be an array substrate or a color filter substrate. In a case in which the display substrate is the array substrate, the active area specifically includes: a pattern of a gate line and a gate formed by a patterning process; a pattern of a gate insulation layer formed by a patterning process; a pattern of an active layer formed by a patterning process; a pattern of a data line, a source and a drain formed by a patterning process; a pattern of a passivation layer formed by a patterning process; a pattern of a pixel electrode formed by a patterning process and the like. In a case in which the display substrate is a color filter substrate, the active area specifically includes: patterns of color filters of various colors (which may include red, green and blue) formed by multiple patterning processes; a pattern of spacers formed by a patterning process; a pattern of a planarization layer formed by a patterning process and the like.

Specifically, in the step of forming the filter layer, patterns of color filters with the same color as the filter layer may be formed simultaneously, that is, the filter layer and color filters with the same color as the filter layer may be formed by a single patterning process, thus addition of processes and time for manufacturing the display substrate can be avoided, thus large increase in cost of manufacturing the display substrate can be suppressed, and large decrease in production efficiency of the display substrate 1 can be avoided.

Specifically, the step of forming the filter layer comprises: a step of forming a pattern of a first filter layer; and a step of forming a pattern of a second filter layer having a different color from the first filter layer; in the step of forming the pattern of the first filter layer, forming patterns of color filters with the same color as the first filter layer simultaneously; and in the step of forming the pattern of the second filter layer, forming patterns of color filters with the same color as the second filter layer simultaneously. Thus the viewer cannot observe light leakage at the light leaking region completely, and addition of processes and time for manufacturing the display substrate can be avoided, thus large increase in cost of manufacturing the display substrate 1 can be suppressed, and large decrease in production efficiency of the display substrate can be avoided.

The manufacturing method of the display substrate further comprises: a step of cutting along outer edges of the light leaking region to obtain the display substrate, wherein the outer edge of the filter layer is located outside the outer edge of the light leaking region.

By providing the outer edge of the filter layer outside the outer edge of the light leaking region, a case in which part of the light leaking region is not covered by the filter layer due to process error in manufacturing the filter layer can be avoided, in addition, a case in which regions not being covered by the filter layer (which may be regions outside the light leaking region) occurs in the cut display substrate due to the cut accuracy (cut error) can be avoided. Preferably, a distance from the outer edge of the filter layer to the outer edge of the light leaking region adjacent to the outer edge of the filter layer is 0.2˜0.5 mm.

In the manufacturing method of a display substrate provided by the present invention, a step of forming a filter layer covering the light leaking region is included, thus the transmittance of light at light leaking region of the display substrate may be reduced, so that brightness of the light leaking region is decreased, and even the light leaking region does not emit light, therefore, therefore likelihood of viewer observing light leakage at the light leaking region may be decreased.

As still another technical solution, an embodiment of the present invention further provides a display panel, and in this embodiment, the display panel comprises a display substrate and an assembling substrate, wherein the display substrate adopts the above display substrate provided by the above first embodiment or second embodiment.

In the display panel provided by the present invention, as the display panel adopts the display substrate provided by the present invention, thus the transmittance of light at light leaking region of the display substrate may be reduced, so that brightness of the light leaking region is decreased, and even the light leaking region does not emit light, therefore, likelihood of viewer observing light leakage at the light leaking region may be decreased, and light leakage defect of the light leaking region of the display panel is eliminated.

As still another technical solution, an embodiment of the present invention further provides a display device, and in this embodiment, the display device comprises a display panel, wherein the display panel adopts the above display panel provided by the above embodiment. The display device may be any product or component with display function, such as a liquid crystal panel, a mobile phone, a tablet computer, a TV, a display, a notebook computer, a digital image frame, a navigator and the like.

In the display device provided by this embodiment, as the display device adopts the display panel provided by the above embodiment, thus likelihood of viewer observing light leakage at the light leaking region may be decreased, and light leakage defect of the light leaking region of the display panel is eliminated.

It should be understood that, the above embodiments are only exemplary embodiments used to explain the principle of the present invention and the protection scope of the present invention is not limited thereto. The person skilled in the art can make various variations and modifications without departing from the spirit and scope of the present invention, and these variations and modifications should be considered to belong to the protection scope of the invention.

1. A display substrate, comprising an active area, a first black matrix and a light leaking region, the first black matrix surrounding the active area, and the light leaking region surrounding the periphery of the black matrix, wherein the display substrate further comprises a filter layer surrounding the first black matrix, the first filter layer covers the light leaking region so as to reduce the transmittance of light at the light leaking region of the display substrate, and the resistivity of the filter layer is larger than that of the first black matrix.

2. The display substrate of claim 1, wherein the display substrate is formed thereon with color filters with various colors, the filter layer has the same color as color filters with one color, and pattern of the filter layer and patterns of the color filters with the same color as the filter layer are provided in the same layer.

3. The display substrate of claim 1, wherein the color of the filter layer is any one of red, green and blue.

4. The display substrate of claim 2, wherein the color of the filter layer is any one of red, green and blue.

5. The display substrate of claim 1, wherein the filter layer comprises a first filter layer and a second filter layer;
the display substrate is formed thereon with color filters with various colors, the first filter layer has the same color as color filters with one color and the second filter layer has the same color as color filters with another color;
a pattern of the first filter layer and patterns of the color filters with the same color as the first filter layer are provided in the same layer, and a pattern of the second filter layer and patterns of the color filters with the same color as the second filter layer are provided in the same layer.

6. The display substrate of claim 1, wherein the transmittance of the filter layer is less than 30%.

7. The display substrate of claim 1, wherein the filter layer is made of opaque material.

8. The display substrate of claim 1, wherein inner part of the filter layer partially overlaps outer part of the first black matrix.

9. The display substrate of claim 8, wherein a width of an overlapping area between the inner part of the filter layer and the outer part of the first black matrix is 6˜7 μm.

10. A manufacturing method of a display substrate of claim 1, wherein the manufacturing method comprises a step of forming a first black matrix and a step of forming a filter layer, so that the active area and the light leaking region of the display substrate is separated from each other by the first black matrix, the first filter layer covers the light leaking region outside the active area so as to reduce the transmittance of light at the light leaking region of the display substrate, and the resistivity of the filter layer is larger than that of the first black matrix.

11. The manufacturing method of claim 10, wherein in the step of forming the filter layer, patterns of color filters with the same color as the filter layer are formed simultaneously.

12. The manufacturing method of claim 10, wherein the step of forming the filter layer comprises: a step of forming a pattern of a first filter layer; and a step of forming a pattern of a second filter layer having a different color from the first filter layer;
in the step of forming the pattern of the first filter layer, forming patterns of color filters with the same color as the first filter layer simultaneously; and
in the step of forming the pattern of the second filter layer, forming patterns of color filters with the same color as the second filter layer simultaneously.

13. The manufacturing method of claim 10, further comprises a step of cutting along outer edges of the light leaking region to obtain the display substrate,
wherein the outer edge of the filter layer is located outside the outer edge of the light leaking region.

14. The manufacturing method of claim 13, wherein a distance from the outer edge of the filter layer to the outer edge of the light leaking region adjacent to the outer edge of the filter layer is 0.2˜0.5 mm.

15. A display device comprising a display panel, the display panel comprising a display substrate and an assembling substrate, wherein the display substrate is the display panel of claim 1.
